(19) United States
(12) Patent Application Publication
(10) Pub. No.: US 2025/0005327 A1
(43) Pub. Date: Jan. 2, 2025

(54) Convolution Attention Network for Multi-Label Clinical Document Classification

(71) Applicant: Solventum Intellectual Properties Company, Maplewood, MN (US)

(72) Inventors: Yang Liu, Mercer Island, WA (US); Hua Cheng, Pittsburgh, PA (US); Russell I. Klopfer, Pittsburgh, PA (US); Thomas Schaaf, Pittsburgh, PA (US); Matthew R. Gormley, Pittsburgh, PA (US)

(21) Appl. No.: 18/691,766

(22) PCT Filed: Sep. 8, 2022
(86) PCT No.: PCT/IB2022/058478

§ 371 Date: Mar. 13, 2024

Related U.S. Application Data
(60) Provisional application No. 63/261,276, filed on Sep. 16, 2021.

(51) Int. Cl. G06N 3/045

(52) U.S. Cl. CPC G06N 3/045

(57) ABSTRACT

Systems and techniques are described for configuring and training a neural network including receiving a plurality of documents, providing the received documents to a neural network model comprising a deep convolutional-based encoder including a plurality of squeeze-and-excitation (SE) and residual convolutional modules that form a plurality of SE/residual convolutional block pairs, determining a word embedding matrix for the plurality of documents, providing one or more word embeddings in the word embedding matrix to the encoder, generating one or more label-specific representations based on the output of the plurality of SE/residual convolutional block pairs, computing a probability of a label being present in the one or more documents given the one or more label specific representations and using a first loss function to train the model for frequently occurring labels and a second loss function to train the model for rarely occurring labels.

### TECHNICAL FIELD

This disclosure relates to configuration and training of neural networks to improve the accuracy of neural networks used for multi-label document classification (MLDC), for instance, in Computer Assisted Coding (CAC) where multiple billing codes are assigned to a clinical document.

### BACKGROUND

MLDC is a natural language processing technique for assigning one or more labels from a collection of labels to a particular document in a document corpus based on the text contained within the document. It differs from the multi-class classification techniques where each document is tagged with only one label.

MLDC has a great number of practical applications. One of the use cases is the automatic medical coding, where the medical records are assigned with multiple appropriate medical codes. A huge number of medical records need to be coded for billing purposes every day. Professional clinical coders often use rule-based or simple machine-learning-based systems to assign the right billing codes to a patient encounter, which usually contains multiple documents with thousands of tokens. The large billing code space (e.g., the ICD-10 code system with over seventy thousand codes) and long documents are especially challenging for machine learning models implementing traditional MLDC approaches. Consequently, effective models with the capability of handling these challenges will have an immense impact in the medical domain as they help to reduce coding cost, improve coding accuracy and increase customer satisfaction.

Deep learning methods have been demonstrated to produce the state-of-the-art outcomes on benchmark MLDC tasks but demands remain for more effective and accurate solutions. For example, existing convolution methods rely on overly simple architectures, and standard transformer-based models can only process a few hundred input tokens.

### SUMMARY

The present disclosure describes systems and techniques for configuring and training a neural network to improve the accuracy of the network used for MLDC. In a first aspect, a system can include one or more computer processors, a non-transitory computer-readable storage medium communicatively coupled to the one or more computer processors, and a machine learning model for multi-label clinical document classification stored on the storage medium. In the first aspect, the model can include an input layer that automatically transforms one or more documents into a plurality of word embeddings, a deep convolutional-based encoder that automatically combines information of adjacent words present in the documents and learns one or more representations of the words present in the documents, an attention component that automatically selects one or more document features and generates label-specific representations for a plurality of identified labels and an output layer that produces zero or more final classification predictions. The word embeddings included in the system can be pretrained word embeddings and the pretrained word embeddings can be determined using a skip-gram technique. The pretrained word embeddings be context insensitive or context sensitive.

In the first aspect, the documents can be unstructured documents. The final classification prediction can include one or more probabilities that one or more respective labels in the plurality of labels are present in the text of the one or more documents. The deep convolutional-based encoder can further include a plurality of squeeze-and-excitation (SE) and residual convolutional modules. The SE and residual convolutional blocks can form an SE/residual convolutional block pair, and the SE and residual convolutional blocks in each pair are independent but receive the same data. The SE convolutional module can include an SE network followed by a layer normalization component. The SE network can include one or more one-dimensional convolutional layers, a global average pooling component, a squeeze component, and an excitation component. The deep convolutional-based encoder can include a plurality of encoding blocks. The attention component can be configured to extract all outputs form the plurality of encoding blocks. The attention component can automatically select the most important text features. The model can identify both frequently occurring and rarely occurring labels in the documents using a first determination for the frequently occurring labels and a second determination for the rarely occur labels. The first determination can be a binary cross entropy loss determination and the second determination can be a focal loss determination. The one or more documents can be represented by a word embedding matrix that includes each of the transferred word embeddings.

In a second aspect, a method for training the neural network is disclosed, including receiving a plurality of documents, providing the received documents to a neural network model comprising a deep convolutional-based encoder including a plurality of squeeze-and-excitation (SE) and residual convolutional modules that form a plurality of SE/residual convolutional block pairs, determining a word embedding matrix for the plurality of documents, providing one or more word embeddings in the word embedding matrix to the encoder, generating one or more label-specific representations based on the output of the plurality of SE/residual convolutional block pairs, computing a probability of a label being present in the one or more documents given the one or more label specific representations, and using a first loss function to train the model for frequently occurring labels and a second loss function to train the model for rarely occurring labels, wherein the first loss function is used until the model performance saturates using the first loss function before training the model using the second loss function.

In the second aspect, the first loss function is a binary cross entropy loss function and the second loss function is a focal loss function. Providing each word embedding can include providing each word embedding to each SE/residual module pair. Providing each word embedding to each SE/residual module pair can also include providing each word embedding to the SE module, which can include computing one or more channel-dependent coefficients using a two-stage computation, and normalizing the computed channel-dependent coefficients to generate an SE module output and simultaneously providing each word embedding to the residual module, which can include transforming the word embeddings using a filter-size-1 convolutional layer, and adding the transformed word embeddings with the SE module output generating the output of the SE/residual convolutional block pair. The two-stage computation can include in a first stage of the two-stage computation, compressing each channel into a single numeric value, and in a second stage of the two-stage computation, processing each channel using a dimensionality-reducing computation with a reduction ratio, and processing each channel using a dimensionality-increasing computation to return the channel to its original dimension.

In the second aspect, instead of providing each word embedding to an SE/residual convolutional block pair, an output from a previous layer in the neural network model can be provided to the SE/residual convolutional block.

### BRIEF DESCRIPTION OF DRAWINGS

FIG. 1 is a block diagram illustrating an example neural network configuration, in accordance with various aspects of the disclosure.

FIG. 2 is a block diagram illustrating an example configuration of a Res-SE block, in accordance with various aspects of the disclosure.

FIG. 3 is a block diagram illustrating an example configuration of an SE module, in accordance with various aspects of the disclosure.

FIG. 4 is a flowchart illustrating an example technique for training a neural network, in accordance with various aspects of the disclosure.

FIG. 5 is an illustration depicting an example processing unit that operates in accordance with the techniques of the disclosure.

### DETAILED DESCRIPTION

Systems and techniques are described that utilize and train a neural network in accordance with various aspects of the disclosure. In general, the neural network is arranged into four primary components: an input layer, a deep convolution based-encoder, an attention component, and an output layer. The disclosure also describes additional techniques that are used to enhance the results of the specified model. For example, to obtain high-quality representations of the document texts, we incorporate the squeeze-and-excitation (SE) network and the residual network into the convolution-based encoder. Furthermore, the convolution-based encoder consists of multiple encoding blocks so as to enlarge the receptive field and capture text patterns with different lengths. This can be important, for example, when used in processing documents in the medical field, and particularly as it relates to unstructured text (e.g., represented by a dictation in the medical record) where the text patterns are unlikely to have a uniform length.

Another example of an enhancement described herein pertains to the manner in which attention is performed. Specifically, according to various aspects of the disclosure, instead of only using the last encoder layer output, the systems and techniques that implement the instant disclosure are configured to extract all encoding layer outputs and to apply the attention computation on all outputs to select the most informative features for each label. In other words, the system and techniques disclosed herein can be used to select one or more phrases describing the specific clinical conditions that be used to generate a code or label. For instance, according to particular implementations, the phrase “hypertension” can be selected as the most informative feature assigning the code I10 to a particular document. Yet another example of an enhancement described herein, and to improve the accuracy of the underlying model, is using a combination of one or more loss functions to train the model. For example, the model can first be trained using a binary cross entropy loss function. After the model has saturated (e.g., the accuracy of the model has not improved over one or more epochs), the model is then trained using a focal loss function. By training the model in this way, it was been observed that systems and techniques implementing aspects of the disclosure perform better on both frequent and rare labels that may appear in a document corpus than existing models trained using different techniques.

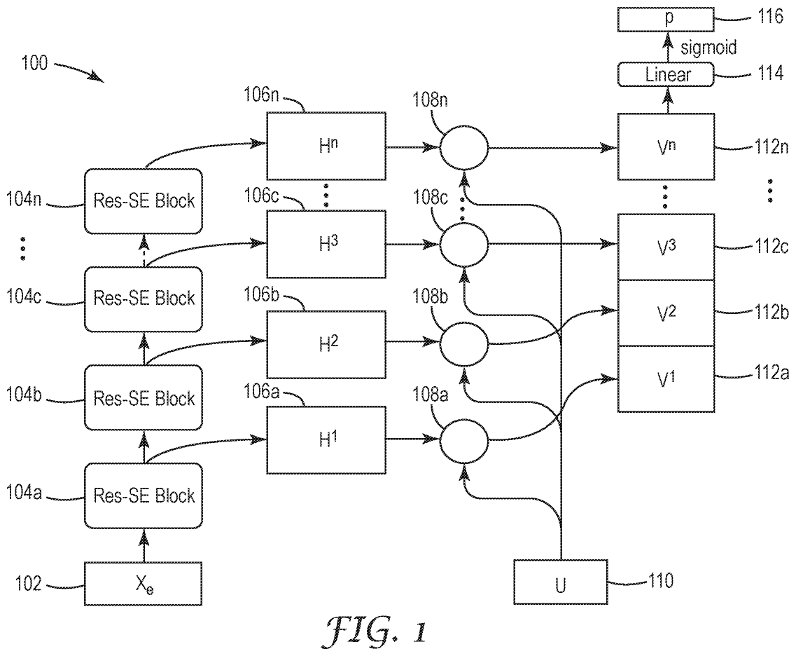

FIG. 1 is a block diagram illustrating an example neural network configuration 100, in accordance with various aspects of the disclosure. As discussed herein, configuration 100 and model 100 may be used interchangeably. As mentioned above, and as shown in FIG. 1, the neural network configuration 100 is composed of four components, or layers, represented by blocks 102, 104a-104n, 108a-108n, and 116, respectively, although it should be understood that additional components can be added to the neural network configuration 100. According to particular implementations, the first component of the neural network configuration 100 is an input layer 102 that transforms the text in one or more document into pretrained word embeddings. The second component is a deep convolution-based encoder (e.g., represented by one or more Res-SE blocks 104a-104n) that combines the information of adjacent words identified in the one or more documents and learns meaningful representations of the document texts. For instance, according to particular implementations, a high dimension vector (e.g., having 256 dimensions) can be used to encode the semantics of one or more portions of document text. In some implementations, the document can be analyzed in 20-word segments. Using a high dimension vector, the neural network 100 would encode text containing “high blood pressure” in a closer dimensional proximity to “hypertension” than “hypotension,” to name one example. The third component is an attention component (e.g., as represented by attention components 108a-108n) that selects the most informative text features, as mentioned above, and generates label-specific representations for each label. For instance, in one implementation, label-specific representations can include a vector of weights that represent the meaning of a label. The weights, and by extension, the label-specific representations, can be further tuned as the model is trained. The fourth component is an output layer 116 that produces the final predictions.

Referring now to the input layer, which is represented by block 102, each of the Res-SE blocks 104a-104n takes a word sequence as input. According to particular implementations, the word sequences can originate from structured documents in a document corpus, unstructured documents in the document corpus, structured or unstructured portions of documents in a document corpus, or combinations thereof. For example, the input layer 102 could receive a sequence of words identified in a medical record containing both structured and unstructured regions. In some implementations, the sequence of words could be an entire encounter between a physician and a patient, or it could be some subset of words related to the encounter, to name two examples. Other sequences are also possible, for instance, portions of the medical record pertaining to a particular diagnosis or procedure over a number of different physician/patient encounters. According to aspects of the present disclosure, the input layer is configured to determine a word embedding for each word in the received sequence of words. As used herein, a word embedding is a learned representation whereby words having the same or similar meaning have the same or similar representation. For instance, the words “yes” and “affirmative” may have similar representations as word embeddings because the definitions may be the same or similar in certain contexts. Conversely, the words “not” and “knot” may have different representations as word embeddings because the meanings of the two words are different regardless of context.

In some implementations, the word embeddings may be pretrained word embeddings. In general, pretrained word embeddings are word embeddings that have been learned or used in one context but may be applied in a different but related context. This may improve the speed at which the underlying model 100 is trained. For example, word embeddings pretrained on general English texts (e.g., online encyclopedia pages) could be suitable for topic classification on social media. In some implementations, the pretrained word embeddings are determined using a conventional technique, such as a skip-gram technique. This means that the resulting pretrained word embeddings are not dependent on the context. For example, the embedding for “dog” will be the same whether it appears in the context “the dog wagged its tail” or “a dog day afternoon.” The benefit of context-insensitive word embeddings is that they can be represented with a simple look up table, which is incredibly efficient. In some implementations, word embeddings may be a function of their current context whereby the embedding for “dog” in the previous example would be different. While context sensitive word embeddings generally lead to more accurate predictions, they are also extremely computationally expensive to compute, often requiring as much or more computational effort than a convolutional neural network (CNN), such as the one described herein. This means, in general, that the pretrained word embeddings are learned without taking into consideration the surrounding words. Likewise, in some implementations, the pretrained word embeddings are context sensitive, which means that the pretrained word embeddings are learned with taking into consideration the surrounding words. For example, the word “knot” may have different meanings associated with the context present in the document in which the word appears, so it would not be unexpected for the context sensitive word embedding for “knot” to differ from the context insensitive word embedding. That said, depending on the application, context sensitive word embeddings do not always outperform context insensitive word embeddings. For example, while it has been observed that contextualized embeddings are much better at sentence level tasks, it's not the case at the document level. Consequently, the choice of whether to use context sensitive or context insensitive embeddings may vary according to particular implementations. And in those particular implementations, it may not be justified to use the more computationally expensive models.

In one implementation, each word is represented by (or transformed into) a word embedding of size dₑ. In general, an embedding can be represented by a vector of numbers, and the size defines how many numbers are in the vector. A vector of size 200 can encode more information about the word than a size 100 vector, for example. Furthermore, in one implementation, the one or more documents to be analyzed may contain N_{w} words. In such an implementation, the word embedding matrix generated by the input layer can be represented by Xₑ=[x₁, . . . , x_{N}_{_{w}}]∈ [symbol] ^{N}^{_{w}}^{×d}^{ₑ}

[symbol]

The convolutional encoder is represented by the Res-SE blocks 104a-104n. In general, the convolutional encoder is configured to transform information received by one or more layers of the model. For instance, the input word embeddings Xₑ generated by the input layer 102 can be provided to the one or more Res-SE blocks 104a-104n. In addition, higher layers in the model 100 can receive input from lower layers of the model 100 to aggregate information. For instance, as depicted in FIG. 1, output produced by Res-SE block 104a is provided to Res-SE block 104b, and Res-SE block 104b provides its output to Res-SEC block 104c. By way of a particular example, this may represent lower levels of the model 100 extracting features from smaller subdivisions or groupings of the text within the documents while higher layers in the model 100 aggregate the lower level features to form representations of larger subdivisions or groupings of text with the documents.

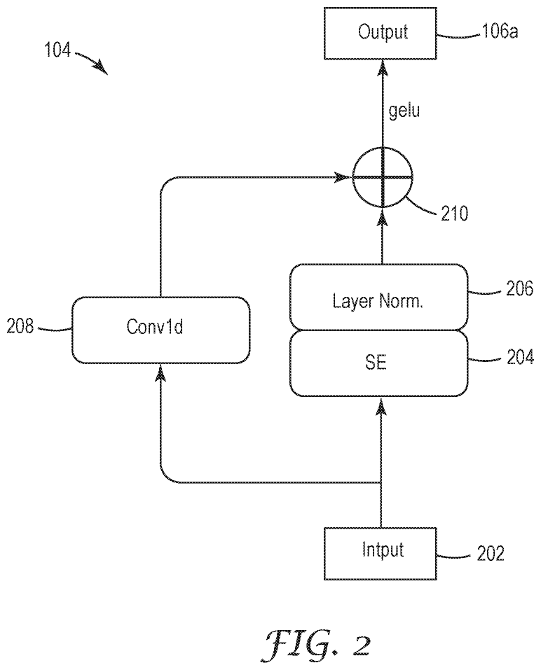

According to one implementation, each Res-SE block is made up of a residual squeeze-and-excitation convolutional block. The Res-SE blocks 104a-104n present in the convolutional encoder, and the manner in which the Res-SE blocks 104a-104n transform information will be described in more detail with respect to FIG. 2, below. According to particular implementations, the outputs of each Res-SE block 104a-104n is represented by blocks 106a-106n, respectively.

According to particular implementations, the outputs 106a-106n are provided to the attention layer, represented by components 108a-108n in FIG. 1. According to one implementation, the attention layer implements a label-wise attention to generate label specific representations from output 106a-106n. For instance, if the labels are “cat” and “dog,” the “dog” weights would higher for representations produced from dog-related text, such as “panting,” “wagging tail,” “playing fetch,” etc. As another example, “hypertension” and/or “high blood pressure” could be used as label-specific representations for the billing code I10. In other words, as it relates to label-specific representations, each billing code has a specific representation based on the relevant phrases in the document. Because the convolutional encoder layer includes multiple Res-SE blocks 104a-104n, the attention layer is configured to perform multi-layer attention. This allows, for example, that when each label is selected by the attention layer, the most relevant label from a rich feature space (e.g., different features from multiple convolutional layers) extracted by the convolution encoder layer can be selected. As appreciated by someone of ordinary skill in the art, this provides various benefits over a model that selects the most relevant label from just one convolutional layer.

According to one implementation, to attend to the i^{th} Res-SE layer output (e.g., as depicted in FIG. 1, 106a represents the first Res-SE layer output where 106n represents the i^{th} Res-SE layer output), is represented mathematically by Hⁱ∈ [symbol] ^{N}^{_{w}}^{d}^{_{conv}}^{ⁱ} and where a label embedding matrix 110 is defined mathematically as U∈ [symbol] ^{N}^{ₗ}^{×d}^{ₗ}, where Nₗ is the number of the labels in label embedding matrix and dₗ is the embedding size of each label, the attention weights can be computed as follows. First, U is mapped to U′∈ [symbol] ^{N}^{ₗ}^{×d}^{_{conv}}^{ⁱ} using a filter-size-1 convolutional layer to avoid dimension mismatch, although other techniques to transfer or map matrix U to U′ can also be used. After U has been mapped to U′, the attention weights can be computed. In one implementation, the attention weights are defined by the mathematical equation Aⁱ=softmax(U′·Hⁱ^{^{T}}). In general, softmax normalizes a vector of N values into a vector of N real values that sum to 1. The input values can be positive, negative, zero, or greater than one, but the softmax transforms them into values between 0 and 1, so that they can be interpreted as probabilities. Here the j^{th} column of Aⁱ∈ [symbol] ^{N}^{ₗ}^{×N}^{_{w}} is a weight vector measuring or otherwise indicating how informative the text representations in Hare for the j^{th} label. In other words, the weight vector Aⁱ measures how much impact the text representations in H should have on the j^{th} label. The next step in the attention determination is to generate the label specific representations by multiplying the attention weights Aⁱ with Hᵢ, or Vᵢ=Aᵢ·Hᵢ. Referring again to FIG. 1, these attention determinations are depicted as blocks 112a-112n. For each of the attention outputs 112a-112n, the j^{th} column in Vⁱ∈ [symbol] ^{N}^{ₗ}^{×d}^{_{conv}}^{ⁱ} is the label specific representation of the j^{th} label, generated from the i^{th} Res-SE layer output. In other words, attention output 112a contains all labels generated from the first Res-SE layer 104a's output 106a, attention output 112b contains all labels generated from the second Res-SE layer 104b's output 106b, etc. This attention determination is repeated for all Res-SE blocks' 104a-104n outputs 106a-106n. The model 100 then takes all of the results and concatenates the label specification representations. For instance, as depicted in FIG. 1, the attention outputs 112a-112n are concatenated and provided to output layer 114. In one implementation, this can be defined mathematically as V=concat(Vⁱ, . . . , V^{N}^{_{Res-SE}}), where N_{Res-SE} is the number of Res-SE blocks in configuration 100. This results in a value for V, expressed as V∈ [symbol] ^{N}^{ₗ}×Σᵢd_{conv}ⁱ, that can be provided to the output layers 114 and 116 and used to determine final predictions.

In other implementations, where the application domain has a large label space, but insufficient data points, a multi-layer attention model may be difficult to train. In such implementations, it may be advantageous to instead use a sum-pooling attention in model 100 where each convolutional layer is first transformed to have the same dimension as the last layer, then sum all layers before applying attention to the summed output. In such implementations, the resulting vector V′∈ [symbol] ^{N}^{₁}^{×d}^{_{conv}}^{^{last-layer}} is used for the final predictions. For instance, in some implementations it has been observed that sum-pooling performs better than multi-layer attention on prediction tasks involving a full code set (e.g., a code set of 8,922 codes), while multi-layer attention performs better than sum-pooling on prediction tasks involving only the 50 or so most frequently appearing codes in the same code set.

The output layers 114 and 116 receives label specification representations and use those label specific representations to compute the probability that each label appears in the document corpus. In one implementation, the probability determinations leverage the fully connected layer (e.g., represented by block 114) and performing both a sum-pooling operation and a sigmoid transformation (represented by block 116). The probability p can be represented thusly: p=sigmoid(pooling(W_{f}_{_{c}}·V^{T}+b_{f}_{_{c}})), where W_{f}_{_{c}}∈ [symbol] ^{Σ}^{ᵢ}^{d}^{_{conv}}^{ⁱ}^{×N}^{ₗ} and b_{f}_{_{c}}∈ [symbol] ^{N}^{ₗ}. Based on these calculations, the j^{th} value in p is the predicated probability for the j^{th} label to be present given the text in one or more documents.

FIG. 2 is a block diagram illustrating an example configuration of an Res-SE block 104, in accordance with various aspects of the disclosure. In general, the Res-SE block 104 includes a squeeze-and-excitation (SE) module 204 (also referred to as an SE network), and a residual module 208. The SE module 204 and the residual module 208 are considered independent from each other because, for example, they both receive the same input 202, and the output of SE module 204 is not provided to the residual module 208, or vice versa. Contrast the configuration of SE module 204 and the residual module 208 with the configuration of the SE module 204 and the layer normalizer module 206. In the latter case, layer normalizer module 206 is considered dependent on the SE module 204 because the layer normalizer module 206 depends on the output from the SE module 204 to perform the technique for which the layer normalizer module 206 is configured.

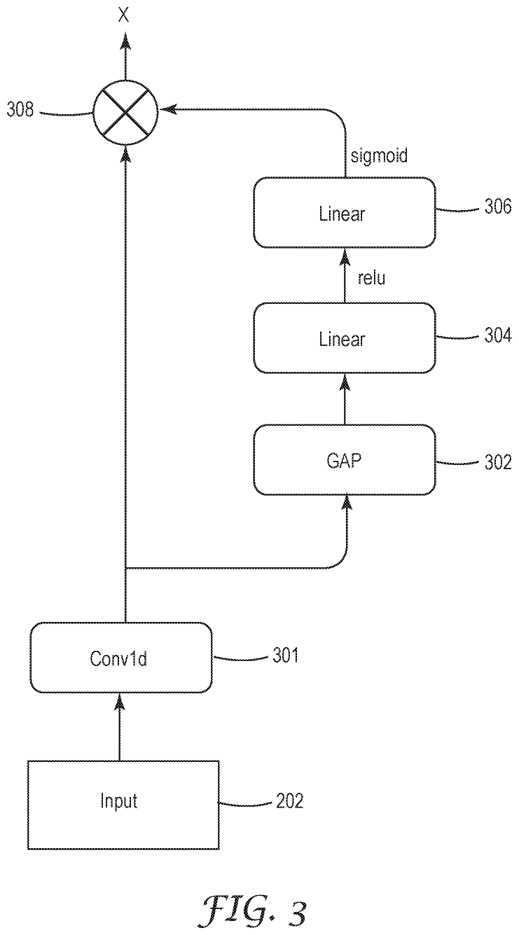

Referring back to the SE module 204, the module 204 is configured to improve the performance of neural network configuration 100 by, e.g., enhancing the learning of document representations that ultimately improve prediction tasks (such as predictions made by the output layer 116) of the neural network configuration 100. At a high level, the SE module 204 receives input 202, such as input X, and according to various computations, produces an output denoted as \tilde{X}. The manner in which the SE module 204 is configured to produce output \tilde{X} is further described in FIG. 3. After the SE module 204 produces output, the output is provided to the layer normalizer module 206, which can use any number of techniques to produce normalized output. For instance, normalization performed by the layer normalizer module 206 can stabilize hidden layer distributions and smooth gradients in natural language processing (NLP) tasks, according to particular implementations.

The Res-SE block 104 also simultaneously provides input 202, such as input X, to the residual module 208. The residual module 208 is configured to take input 202 and transform the input 202 using a filter-size-1 convolutional layer. For instance, using the filter-size-1 convolutional layer, input X can be transformed into X′. The Res-SE block 104 can then add the SE module 204's output \tilde{X} with the residual module 208's output X′, as represented by block 210. Finally, a gelu activation function (or Gaussian Error Linear Units activation function) can be applied to the sum of \tilde{X} and X′ to produce the output of the Res-SE block 104, which is denoted as H (e.g., blocks 106a-106n in FIG. 1). In other words, the output H of the Res-SE block 104 can be represented as H=gelu(\tilde{X}+X′).

FIG. 3 is a block diagram illustrating an example configuration of an SE module 204, in accordance with various aspects of the disclosure. Input 202 can originate from a variety of sources depending on where in the model 100 the SE module 204 is located. For instance, with respect to FIG. 1, input 202 can be input layer 102 provided to Res-SE block 104a. In addition, input 202 can be the output of Res-SE block 104a that is provided to Res-SE block 104b, or any other output of a lower-level Res-SE block 104 provided to a higher-level Res-SE block 104 as described above. In the depicted example, input 202 is first provided to a 1-dimensional convolutional layer 301 to aggregate the information of adjacent word embeddings. For instance, according to particular input 202, the 1-dimensional convolutional layer 301 can identify that the words “phone”+“call” are different word embeddings than the words “phone”+“booth.” In other words, even though the model may generate context insensitive word embeddings the model can use information related to adjacent word embeddings to approximate the accuracy of context sensitive word embeddings without requiring the computational costs associated with context sensitive models. In one implementation, the 1-dimensional convolutional layer 301 applies a filter on input 202 represented as W_{c}∈ [symbol] ^{k×d}^{ₑ}^{×d}^{_{conv}}, where k is the filter size, dₑ is the in-channel size [symbol] (i.e., the size of the input embeddings) and d_{conv} is the out-channel size (i.e., the size of the output embeddings). Applying this 1-dimensional convolutional filter to input 202 represented as input X, the 1-dimensional convolution is computed as: cᵢ=W_{c}*x_{i:i-k+1}+b_{c}, where * is the convolutional operation and b_{c} is the bias. In accordance with aspects of this disclosure, the output convolutional features can be represented as C=[c₁, . . . , c_{N}_{_{w}}], where C∈ [symbol] ^{N}^{_{w}}^{×d}^{_{conv}}.

After C is determined by the 1-dimensional convolutional layer 208, the SE module 204 use a two-stage process: “squeeze” and “excitation” to compute the channel-dependent coefficients to enhance the convolutional features. According to one implementation, the “squeeze” stage is represented by the GAP component 302, and the “excitation” stage is represented by the two linear components 304 and 306, respectively.

In the “squeeze” stage represented by the GAP component 302, each channel (or single dimension in the multiple dimensional input produced by a 1-dimensional convolutional layer 301) is compressed into a single numeric value via global average pooling (GAP). GAP can be defined as z_{c}=GAP(C), where z_{c}∈ [symbol] ^{d}^{_{conv}} and can be treated as a channel descriptor that aggregates the global spatial information of C.

In the “excitation” stage, the channel descriptor z_{c} is provided first to a dimensionality-reduction-layer 304, which has a reduction ratio r. The reduction ratio r is a hyperparameter that can be tuned. In one particular implementation, r is 20 based on empirical evaluation of results of the model 100, although r can be any value according to desired outcomes. After the dimensionality-reduction performed by layer 304, the channel descriptor z_{c} is next provided to a dimensionality-increasing-layer 306. Layer 306 increases the channel dimension back to the channel dimension of C. This two-stage process of first providing the channel descriptor z_{c} to dimensionality-reduction-layer 304 and then to dimensionality-increasing-layer 306 can be defined as follows:

$${s}_{c} = sigmoid ( {W}_{{fc}_{2}} \cdot relu ( {W}_{{fc}_{1}} \cdot {z}_{c} + {b}_{{fc}_{1}} ) + {b}_{{fc}_{2}} ) , where {W}_{{fc}_{1}} ∈ {ℝ}^{\frac{{d}_{conv}}{r} \times {d}_{conv}} , {b}_{{fc}_{1}} ∈ {ℝ}^{\frac{{d}_{conv}}{r}} , {W}_{{fc}_{2}} ∈ {ℝ}^{{d}_{conv} \times \frac{{d}_{conv}}{r}} , and {b}_{{fc}_{2}} ∈ {ℝ}^{{d}_{conv}}$$

are the weights and biases of the fully-connected layers 304 and 306.

After the SE module 204 computes s_{c}, component 308 rescales the convolutional feature C by the value s_{c}, or \tilde{X}=scale(C, s_{c}), where scale denotes the channel-wise multiplication between C and se. Finally, \tilde{X} can be normalized and used as the output of the SE module 204. As described above in reference to FIG. 2, SE module 204 produces an output X that is used by other aspects of the neural network configuration 100. For instance, as described above, the output H of the Res-SE block 104 can be represented as H=gelu(\tilde{X}+X′).

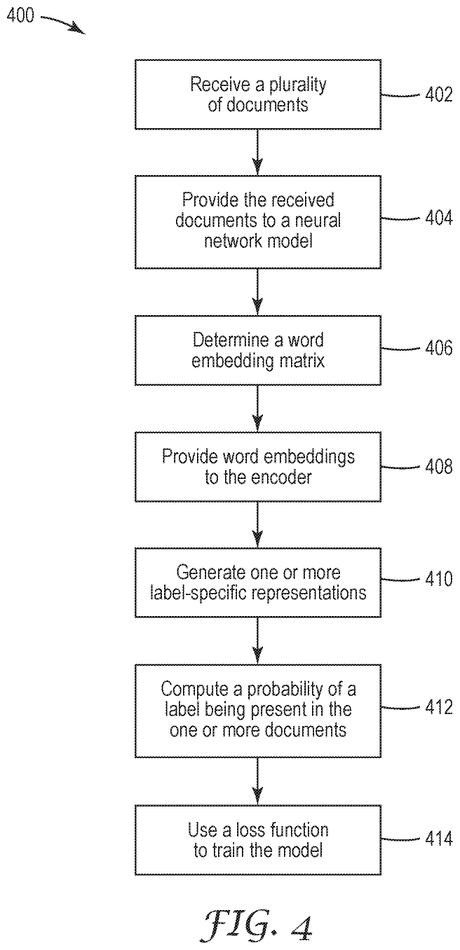

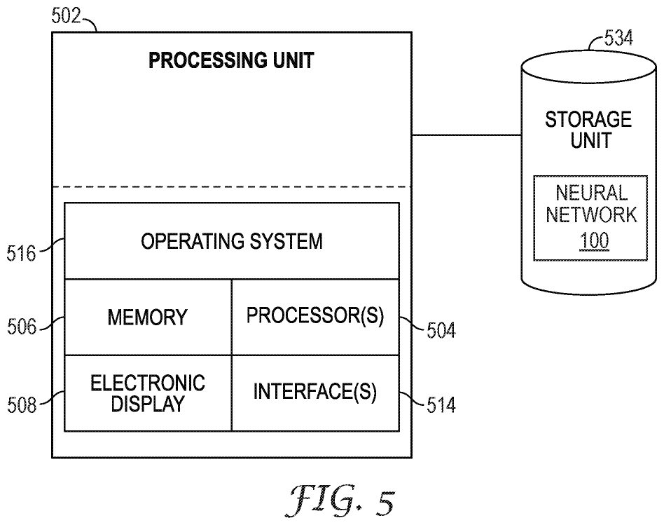

In order for the neural network model 100 as described above to accurately predict the presence of labels in the text of a document corpus, the model 100 must be trained. FIG. 4 is a flowchart illustrating an example technique 400 for training a neural network, in accordance with various aspects of the disclosure. The technique is described in relation to a system, such as a processing unit 502 depicted in FIG. 5, below, although it should be understood that other computing systems can be configured to implement technique 400. Technique 400 is also described in reference to the neural network configuration 100 described in reference to FIG. 1, although other neural network configurations can be trained using the disclosed technique 400. At step 402, the system receives a plurality of documents. For instance, the documents could be stored on storage units 534, or could be communicated via a computer network communicatively coupling processing unit 502 with another computer device. In one implementation, the documents are related to one more medical encounters between one or more medical providers and a patient.

In step 404, the system provides the received documents to a neural network model. For instance, according to particular implementations, the received documents can be provided to neural network model 100.

In step 406, a word embedding matrix is determined. For example, as described above in connection with FIG. 1, the input layer 102 can determine the word embedding matrix. In accordance with particular implementations, each word can be represented by (or transformed into) a word embedding of size dₑ and the one or more documents to be analyzed may contain N_{w} words. As a result, the word embedding matrix generated by the input layer 102 can be represented by the equation Xₑ=[x₁, . . . , x_{N}_{_{w}}]∈ [symbol] ^{N}^{_{w}}^{×d}^{ₑ}.

In step 408, the system provides the word embeddings to an encoder. For example, as described above in reference to FIG. 1, the convolutional encoder can be by the Res-SE blocks 104a-104n and can be configured to transform information received by the input layer 102, as well as outputs from Res-SE blocks at lower levels in the model 100. For instance, the input word embeddings Xₑ generated by the input layer 102 can be provided to the one or more Res-SE blocks 104a-104n. As another example, the output of Res-SE block 104a can be provided to Res-SE block 104b as block 104b's input. According to particular implementations, and described above in connection to FIG. 2, the input word embeddings Xₑ can be provided both to the SE module 204 and to the residual module 208, simultaneously. The SE module 204 produces output X as described in more detail in connection to FIGS. 2 and 3, above. For instance, the SE module 204 may first provide input 202 to a 1-dimensional convolutional layer 208 to aggregate the information of adjacent word embeddings. Next, the SE module 204 can use a two-stage process: “squeeze” and “excitation” to compute the channel-dependent coefficients to enhance the convolutional features. According to one implementation, the “squeeze” stage is represented by the GAP component 302, and the “excitation” stage is represented by the two linear components 304 and 306, respectively. After the SE module 204 rescales computed convolutional features and normalizes the rescaled convolutional features to produce output \tilde{X} to be used as the output of the SE module 204.

Also, as described above in FIG. 2, The residual module 208 is configured to take input 202 and transform the input 202 using a filter-size-1 convolutional layer. For instance, using the filter-size-1 convolutional layer, input \tilde{X} can be transformed into X′. The Res-SE block 104 can then add the SE module 204's output \tilde{X} with the residual module 208's output X′, as represented by block 210. In other words, the Res-SE block 104 can produce output H which is based on both \tilde{X} and X′.

In step 410, the system generates one or more label-specific representations. For instance, as described above in reference to FIG. 1, the attention layer represented by blocks 108a-108n can determine one or more label-specific representations from the outputs 106a-106n (e.g., outputs H^{l} to Hⁿ) of the Res-SE blocks 104a-104n. Stated differently, the blocks 112a-112n represent the one or more label specific representations generated by the model 100. According to particular implementations, the model 100 then processes the label specific representations and concatenates the label specification representations. In one implementation, this can be defined mathematically as V=concat(Vⁱ, . . . , V^{N}^{_{ReS-SE}}), where N_{Res-SE} is the number of Res-SE blocks in configuration 100. This results in a value for V, expressed as V∈ [symbol] ^{N}^{ₗ}^{×Σ}^{ᵢ}^{d}^{_{conv}}^{ⁱ}, that can be provided to the output layer 116 and used to determine final predictions.

In step 412, the system computes a probability of a label being present in the one or more documents. For instance, as showing in FIG. 1, output layer 116 can receive the V concatenated and through a fully connected layer 114 and predict whether each label is in the document corpus using a sum-pooling and sigmoid operation as described above. According to particular implementations, if the probability of a label being present is above a certain threshold (e.g., 0.5), the system can add that label to an auto-coding result.

In step 414, the system uses a loss function to train the model 100. According to particular implementations, the system uses a first loss function to train the model 100 for frequently occurring labels and a second loss function to train the model 100 for rarely occurring labels. For instance, the system can first use a binary cross entropy loss function to train the model 100. One such binary cross entropy loss function can be represented mathematically as follows: L_{BCE}(pₜ)=−log pₜ, where pₜ is defined as

$${p}_{t} = \{ \begin{matrix}p & y != 1 \\ 1 - p & otherwise\end{matrix} ,$$

where p is the predicted probability andy represents whether human inspection indicates that a label is or is not present in a particular document.

Technique 400 can be run over a number of epochs, or iterations. As the model 100 is trained the results of training the model 100 may yield diminishing returns. At some point, the training is likely to saturate, which means that only negligible improvements in the accuracy of model 100 can be realized through further training. After the model 100 training saturates, the loss function can be changed, and the model 100 can continue to be trained. In one implementation, the second loss that is used is intended to train the model 100 to identify rare labels (i.e., labels that occur infrequently in a document corpus). For instance, the focal loss function can be used to handle long-tail distribution of the labels (i.e., rare labels in the text of the document corpus). In general, the focal loss function dynamically reduces the loss weights assigned to well-classified labels which makes the model more sensitive to labels that are less well-classified. According to one implementation, that focal loss function can be defined by the following mathematical representation: L_{FL}(pₜ)=−(1−pₜ)^{γ} log pₜ, where γ is a tunable parameter to adjust the strength (or influence) by which the loss weights are reduced. In other words, the weight term (1−pₜ)^{γ} suppresses the loss from well-classified labels (where pₜ tends to be high) and “focuses” the loss on labels that get less confident predictions.

Ultimately, using the neural network configuration 100 and training techniques described herein, improved predictive characteristics over other models and other training techniques have been observed. For instance, depending on the benchmark data used to conduct benchmark testing, a significant improvement in accuracy has been realized. Improvements to the underling accuracy of the system can yield numerous technical and financial benefits. For instance, by improving accuracy without the need to implement more computationally expensive models, computational resources of the computing environment are conserved.

FIG. 5 is an illustration depicting an example processing unit 502 that operates in accordance with the techniques of the disclosure. The processing unit 502 provides a hardware environment for the training of the neural network described above. For example, the processing unit 502 may perform technique 400 to train the neural network configuration 100.

In this example, processing unit includes processing circuitry that may include one or more processors 504 and memory 506 that, in some examples, provide a computer platform for executing an operating system 516, which may be a real-time multitasking operating system, for instance, or other type of operating system. In turn, operating system 816 provides a multitasking operating environment for executing one or more software components such as application 518. Processors 504 are coupled to one or more I/O interfaces 814, which provide I/O interfaces for communicating with devices such as a keyboard, controllers, display devices, image capture devices, other computing systems, and the like. Moreover, the one or more I/O interfaces 514 may include one or more wired or wireless network interface controllers (NICs) for communicating with a network. Additionally, processors 504 may be coupled to electronic display 508.

In some examples, processors 504 and memory 506 may be separate, discrete components. In other examples, memory 506 may be on-chip memory collocated with processors 504 within a single integrated circuit. There may be multiple instances of processing circuitry (e.g., multiple processors 504 and/or memory 506) within processing unit 502 to facilitate executing applications in parallel. The multiple instances may be of the same type, e.g., a multiprocessor system or a multicore processor. The multiple instances may be of different types, e.g., a multicore processor with associated multiple graphics processor units (GPUs). In some examples, processor 504 may be implemented as one or more microprocessors, digital signal processors (DSPs), application specific integrated circuits (ASICs), field-programmable gate array (FPGAs), or equivalent discrete or integrated logic circuitry, or a combination of any of the foregoing devices or circuitry.

The architecture of processing unit 502 illustrated in FIG. 5 is shown for example purposes only. Processing unit 502 should not be limited to the illustrated example architecture. In other examples, processing unit 502 may be configured in a variety of ways. Processing unit 502 may be implemented as any suitable computing system, (e.g., at least one server computer, workstation, mainframe, appliance, cloud computing system, and/or other computing system) that may be capable of performing operations and/or functions described in accordance with at least one aspect of the present disclosure. As examples, processing unit 502 can represent a cloud computing system, server computer, desktop computer, server farm, and/or server cluster (or portion thereof). In other examples, processing unit 502 may represent or be implemented through at least one virtualized compute instance (e.g., virtual machines or containers) of a data center, cloud computing system, server farm, and/or server cluster. In some examples, processing unit 802 includes at least one computing device, each computing device having a memory 806 and at least one processor 504.

Storage units 534 may be configured to store information within processing unit 502 during operation. Storage units 534 may include a computer-readable storage medium or computer-readable storage device. In some examples, storage units 534 include at least a short-term memory or a long-term memory. Storage units 534 may include, for example, random access memories (RAM), dynamic random access memories (DRAM), static random access memories (SRAM), magnetic discs, optical discs, flash memories, magnetic discs, optical discs, flash memories, or forms of electrically programmable memories (EPROM) or electrically erasable and programmable memories (EEPROM).

In some examples, storage units 534 are used to store program instructions for execution by processors 504. Storage units 534 may be used by software or applications running on processing unit 502 to store information during program execution and to store results of program execution. For instance, storage units 534 can store the neural network configuration 100 as it is being trained using technique 400.

1. A system comprising:
one or more computer processors;
a non-transitory computer-readable storage medium communicatively coupled to the one or more computer processors; and
a machine learning model for multi-label clinical document classification stored on the storage medium, the model comprising:
an input layer that automatically transforms one or more documents into a plurality of word embeddings;
a deep convolutional-based encoder that automatically combines information of adjacent words present in the documents and learns one or more representations of the words present in the documents;
an attention component that automatically selects one or more document features and generates label-specific representations for a plurality of identified labels; and
an output layer that produces zero or more final classification predictions.

2. The system of claim 1, wherein the word embeddings are pretrained word embeddings.

3. The system of claim 2, wherein the pretrained word embeddings are context insensitive.

4. The system of claim 2, where the pretrained word embeddings are context sensitive.

5. The system of claim 2, wherein the pretrained word embeddings are determined using a skip-gram technique.

6. The system of claim 1, wherein the documents are unstructured documents.

7. The system of claim 1, wherein a final classification prediction includes one or more probabilities that one or more respective labels in the plurality of labels are present in the text of the one or more documents.

8. The system of claim 1, wherein the deep convolutional-based encoder further comprises a plurality of squeeze-and-excitation (SE) and residual convolutional modules.

9. The system of claim 8, wherein the SE and residual convolutional blocks form an SE/residual convolutional block pair, and the SE and residual convolutional blocks in each pair are independent but receive the same data.

10. The system of claim 8, wherein the SE convolutional module comprises an SE network followed by a layer normalization component.

11. The system of claim 10, wherein the SE network comprises:
one or more one-dimensional convolutional layers;
a global average pooling component;
a squeeze component; and
an excitation component.

12. The system of claim 1, wherein the deep convolutional-based encoder comprises a plurality of encoding blocks.

13. The system of claim 12, wherein the attention component is configured to extract all outputs from the plurality of encoding blocks.

14. The system of claim 1, wherein the attention component automatically selects the most important text features.

15. The system of claim 1, wherein the model identifies both frequently occurring and rarely occurring labels in the documents using a first determination for the frequently occurring labels and a second determination for the rarely occur labels.

16. The system of claim 15, wherein the first determination is a binary cross entropy loss determination and the second determination is a focal loss determination.

17. The system of claim 14, wherein the one or more documents is represented by a word embedding matrix that includes each of the transferred word embeddings.

18. A method for training a neural network comprising:
(a) receiving a plurality of documents;
(b) providing the received documents to a neural network model comprising a deep convolutional-based encoder including a plurality of squeeze-and-excitation (SE) and residual convolutional modules that form a plurality of SE/residual convolutional block pairs,
(c) determining a word embedding matrix for the plurality of documents;
(d) providing input including at least one or more word embeddings in the word embedding matrix to the encoder;
(e) generating one or more label-specific representations based on the output of the plurality of SE/residual convolutional block pairs;
(f) computing a probability of a label being present in the one or more documents given the one or more label specific representations; and
(g) using a first loss function to train the model for frequently occurring labels and a second loss function to train the model for rarely occurring labels,
wherein the first loss function is used until the model performance saturates using the first loss function before training the model using the second loss function.

19. The method of claim 18, wherein the first loss function is a binary cross entropy loss function and the second loss function is a focal loss function.

20. The method of claim 18, wherein the encoder is a plurality of SE/residual module pairs and providing each word embedding further comprises providing each word embedding to at least one SE/residual module pair.

21. (canceled)

22. (canceled)

23. (canceled)

24. (canceled)

25. (canceled)
